(19) United States
(12) Patent Application Publication
(10) Pub. No.: US 2015/0186814 A1
(43) Pub. Date: Jul. 2, 2015

(54) SUPPLIER TECHNICAL OVERSIGHT RISK ASSESSMENT

(71) Applicant: The Boeing Company, Seal Beach, CA (US)

(72) Inventors: Thomas Y. Ng, Huntington Beach, CA (US); Sook K. Kim, Newport Coast, CA (US); Dirk B. Shaffron, Bellevue, WA (US); Zaynal A. Pham, Diamond Bar, CA (US); Dennis C. Johnson, Des Peres, MO (US); Jeffrey W. Canady, Long Beach, CA (US); Jennifer J. Painter, St. Peters, MO (US)

(73) Assignee: The Boeing Company, Seal Beach, CA (US)

(21) Appl. No.: 14/146,038

(22) Filed: Jan. 2, 2014

(51) Int. Cl. G06Q 10/06

(52) U.S. Cl. CPC G06Q 10/0635

(57) ABSTRACT

A system is provided that may receive assignment of quantitative risk ratings to respective characteristic elements and respective technical-profile elements based on applicability of the respective characteristic elements to a particular product and a particular manufacturing supplier. And the system may generate a technical risk assessment of the particular manufacturing supplier for the particular product, with the technical risk assessment including a plurality of risk factors each of which may be related to one or more characteristic elements and technical-profile elements. The system may receive assignment of quantitative parameters and calculate risk scores for respective risk factors. For each risk factor, the quantitative parameters may include a likelihood and a consequence, and the risk score may be calculated as a function of the quantitative parameters for the risk factor, and the quantitative risk ratings assigned to the one or more characteristic elements and technical-profile elements related to the risk factor.

### TECHNOLOGICAL FIELD

The present disclosure relates generally to risk assessment and, in particular, to assessing technical risks of one or more suppliers to a program of design, development and manufacturing of a product.

### BACKGROUND

Large programs of design, development and manufacturing can be difficult to manage, particularly for complex products that may include hundreds or thousands of parts and assemblies, and involve many different partners, vendors, suppliers and the like. Issues in these programs may be due to a number of different causes. For example, some programs may employ overly-optimistic, plug-and-play assumptions, which may combine with ineffective internal and external oversight to cause issues. Some programs may lack technical process rigor such as in source selection, supplier technical oversight and the like. And in another example, some programs may lack focus on technical risk identification and mitigation. These programs may in particular lack commitment to communicate, prioritize and aggressively retire technical risk.

In a number of programs, suppliers underlie a number of causes of program issues, whether through ineffective external oversight, source selection, supplier technical oversight or technical risk identification and mitigation. These issues may include those in a number of technical areas such as requirements and expectations, technology maturity, performance validation, system integration, interface compatibility, reliability, producibility, maintainability, and the like.

Issues with requirements and expectations may often be avoided or their likelihood reduced by well-documented and agreed upon product and performance requirements and expectations, and by documenting, resolving and communicating (in a timely manner) any “to-be-determined” parameters. Technology maturity levels of key components or process may affect the design approach, and may be reduced through their assessment for risk likelihood and consequence implications. Some issues may be avoided through proper management and monitoring during the entire lifecycle of the procurement process, including those in areas such as performance validation, interface compatibility, product and system reliability, producibility, maintainability and the like may be critical to overall system integrity. Other factors may also be monitored and, if necessary, supported such as those in areas such as project and schedule management, risk identification and issue resolution, product and data quality, and the like. More generally, these and other similar program issues may be avoided or reduced by periodic assessment and identification of any high risks, which may be followed by risk mitigation planning and execution of risk mitigation steps as part of program plan activities.

Although existing techniques for addressing these causes and the issues they create may be adequate, it is generally desirable to improve upon existing techniques.

### BRIEF SUMMARY

Example implementations of the present disclosure provide a system and method of assessing technical risks of one or more suppliers to a program of design, development and manufacturing of a product. Example implementations may provide a systemic approach to assess major technical areas that may be problematic when dealing with suppliers, especially on programs involved with significant design development content. The prescribed areas and related attributes may be examined based on the supplier's historical performance or projected ability to perform, resources available or committed, its culture and background, and working relationship with its customer such as the manufacturer of the product.

In accordance with example implementations, predetermined links may be established to adjust weights of various areas based on assessment results, with a total score displayed in an understandable risk management format for review. Because the customer's quality level of technical support to the supplier may impact the performance of the supplier, example implementations may also provide an assessment in the corresponding areas of the customer's technical support activities and provide self-assessment results in similar format for comparison and user consideration. Example implementations may further incorporate risk mitigation aspects to facilitate determination of next courses of action in a risk management process. Properly managed risks may result in reduced likelihood or consequence impact or elimination of the risks to the supplier and program, and therefore improve overall program performance.

According to one aspect of example implementations, a system is provided that includes a product storage and technical-profile storage, a risk-rating applicator coupled to the respective storage, and a risk assessor coupled to the risk-rating applicator. The product storage may be configured to store characteristic elements applicable to one or more products, and the technical-profile storage may be configured to store technical-profile elements applicable to one or more manufacturing suppliers. The risk-rating applicator may be configured to receive assignment of quantitative risk ratings to respective characteristic elements and respective technical-profile elements based on applicability of the respective characteristic elements to a particular product and a particular manufacturing supplier.

The risk assessor may be configured to generate a technical risk assessment of the particular manufacturing supplier for the particular product, with the technical risk assessment including a plurality of risk factors each of which may be related to one or more characteristic elements and technical-profile elements. The risk assessor may be configured to receive assignment of quantitative parameters and calculate risk scores for respective risk factors. For each risk factor, the quantitative parameters may include a likelihood and a consequence, and the risk score may be calculated as a function of the quantitative parameters for the risk factor, and the quantitative risk ratings assigned to the characteristic element(s) and technical-profile element(s) related to the risk factor.

In some examples, for each risk factor, the quantitative parameters may further include a weight of the risk factor relative to others of the risk factors. And in these examples, the risk score may be calculated further as a function of the weight.

In some examples, for each risk factor, the characteristic element(s) and technical-profile element(s) related to the risk factor may be classified in one or more tiers based on their relevance to the risk factor. In these examples, and again for each risk factor, the risk score may be calculated further based on the tier(s) of the characteristic element(s) and technical-profile element(s) related to the risk factor.

In some examples, the product storage, technical-profile storage, risk-rating applicator and risk assessor may be elements of a supplier risk identification system. In these examples, the system may further include an output system coupled to the supplier risk identification system, and configured to generate one or more visual artifacts of the technical risk assessment. Also in these examples, the visual artifact(s) may include a risk matrix on which at least some of the risk factors are identified in an arrangement according to their likelihood and consequence, or a tornado diagram in which at least some of the risk factors are identified based on and in an arrangement according to their risk score.

In some further examples, the risk-rating applicator being configured to receive assignment of quantitative risk ratings may include being configured to receive assignment of quantitative risk ratings to respective technical-profile elements for each of a plurality of particular manufacturing suppliers. In these further examples, the risk assessor being configured to generate the technical risk assessment may include being configured to generate technical risk assessments for respective particular manufacturing suppliers for the particular product. And the output system being configured to generate one or more visual artifacts may include being configured to generate one or more visual artifacts of one or more comparisons of the technical risk assessments.

In some examples, the system including the supplier risk identification system may further include a risk mitigation system coupled to the supplier risk identification system. In these examples, the risk mitigation system may be configured to establish one or more risk descriptors for each of one or more of the risk factors, and one or more risk mitigation actions for each of one or more of the risk descriptors.

In some examples, the technical risk assessment may be generated for a customer of the particular manufacturing supplier for the particular product. In these examples and including the supplier risk identification system, the system may further include a self-assessment system configured to generate a self-assessment of the customer. Here, the self-assessment may include self-assessment elements for respective risk factors of the technical risk assessment. And the self-assessment system being configured to generate the self-assessment may include being configured to receive assignment of quantitative parameters and calculate scores for respective self-assessment elements. For each self-assessment element, the quantitative parameters may include a likelihood and a consequence, and the score may be calculated as a function of the quantitative parameters for the self-assessment elements.

In other aspects of example implementations, a method and computer-readable storage medium are provided. The features, functions and advantages discussed herein may be achieved independently in various example implementations or may be combined in yet other example implementations further details of which may be seen with reference to the following description and drawings.

### BRIEF DESCRIPTION OF THE DRAWING(S)

Having thus described example implementations of the disclosure in general terms, reference will now be made to the accompanying drawings, which are not necessarily drawn to scale, and wherein:

FIG. 1 is an illustration of a STO risk assessment system in accordance with an example implementation;

FIGS. 2 and 3 illustrate a suitable supplier risk identification system and self-assessment system, respectively, according to example implementations of the present disclosure;

FIGS. 4, 5 and 6 illustrate examples of visual artifact(s) of a suitable single-supplier risk assessment, multiple-supplier risk assessment, and self-assessment, respectively, according to example implementations of the present disclosure in which the artifacts may be presented in the form of reports;

FIGS. 7-10, 11A, 11B and 12-16 illustrate example windows of graphical user interfaces (GUIs) that may be navigated by a user to carry out example implementations of the present disclosure; and

FIGS. 17 and 18 illustrate various operations in methods according to example implementations of the present disclosure.

### DETAILED DESCRIPTION

Some implementations of the present disclosure will now be described more fully hereinafter with reference to the accompanying drawings, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Also, something may be shown or described as being above something else (unless otherwise indicated) may instead be below, and vice versa; and similarly, something shown or described as being to the left of something else may instead be to the right, and vice versa. Like reference numerals refer to like elements throughout.

Example implementations of the present disclosure relate generally to risk assessment and, in particular, to assessing technical risks of one or more suppliers to a program of design, development and manufacturing of a product. Example implementations will be primarily described in conjunction with aerospace applications in which the product may be an aircraft composed of component parts such as materials, components, assemblies and sub-assemblies. It should be understood, however, that example implementations may be utilized in conjunction with a variety of other applications, both in the aerospace industry and outside of the aerospace industry.

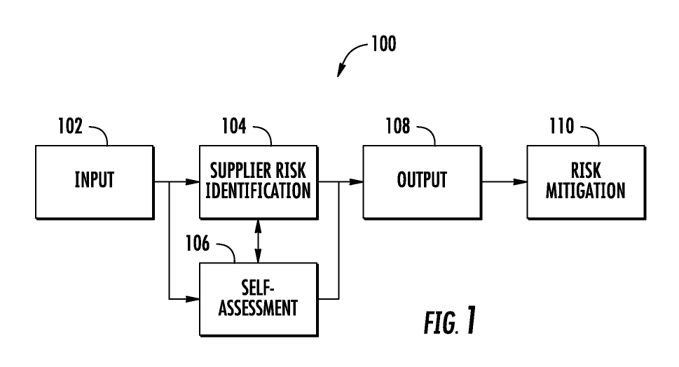

FIG. 1 illustrates a supplier technical oversight (STO) risk assessment system 100 is illustrated according to example implementations of the present disclosure. The system may include any of a number of different subsystems (each an individual system) for performing one or more functions or operations. As shown, for example, the system may include one or more of each of input system 102, supplier risk identification system 104, self-assessment system 106, output system 108 and/or risk mitigation system 110. Although shown as part of the STO risk assessment system, one or more of the input system, supplier risk identification system, self-assessment system, output system and/or risk mitigation system may instead be separate from but in communication with the STO risk assessment system. It should also be understood that one or more of the subsystems may function or operate as a separate system without regard to others of the subsystems. And further, it should be understood that the STO risk assessment system may include one or more additional or alternative subsystems than those shown in FIG. 1.

The input system 102 may be generally configured to receive input regarding a program and one or more particular suppliers who may provide one or more particular products or services (generally “products”) to a customer as part of the program. One example of a suitable program may be the design, development and manufacturing of an aircraft for which component parts (products) such as materials, components, assemblies and sub-assemblies may be provided by appropriate suppliers to the aircraft manufacturer (customer).

The supplier risk identification system 104 may be generally configured to generate technical risk assessment(s) of the particular manufacturing supplier(s) for the particular product(s). Similarly, the self-assessment system 106 may be generally configured to generate a self-assessment of the customer. The output system 108 may be generally configured to generate one or more visual artifacts of the technical risk assessment(s) and/or self-assessment(s). And the risk mitigation system 110 may be generally configured to establish one or more risk descriptors for each of one or more of the risk factors, and one or more risk mitigation actions for each of one or more of the risk descriptors.

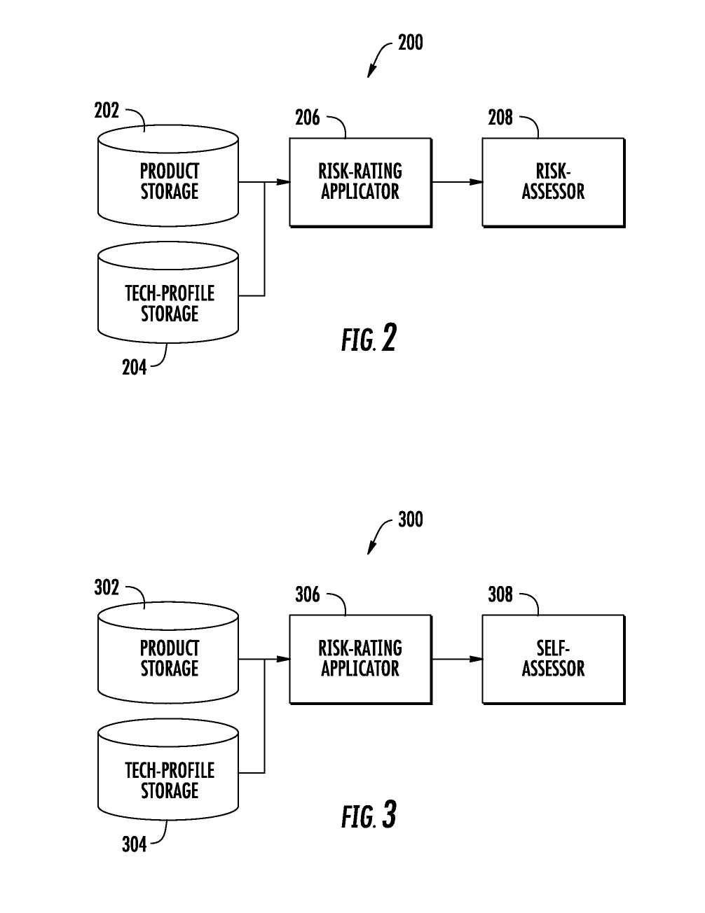

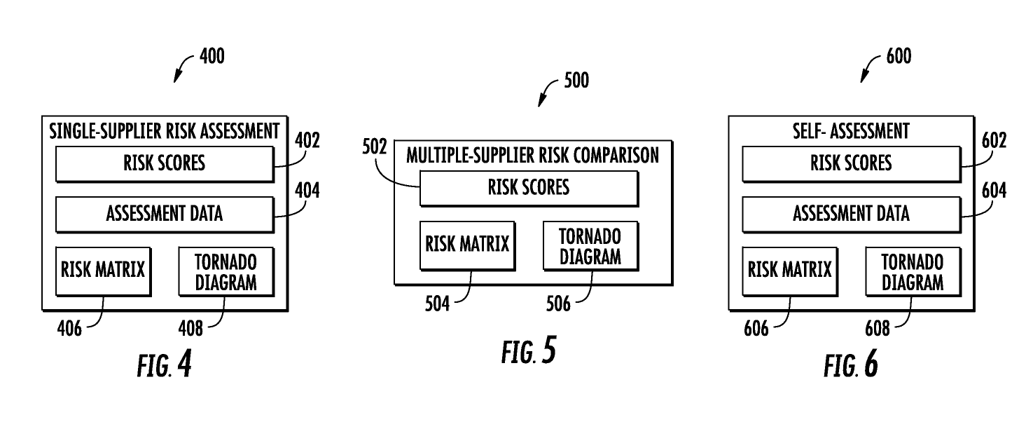

Reference will now be made to FIGS. 2 and 3, which illustrate more particular examples of a suitable supplier risk identification system and self-assessment system, respectively, according to example implementations of the present disclosure.

FIG. 2 illustrates various elements of a suitable supplier risk identification system 200, which in some example implementations of the present disclosure may correspond to the supplier risk identification system 104 of FIG. 1. As indicated above and explained in greater detail below, the supplier risk identification system may be generally configured to generate technical risk assessment(s) of particular manufacturing supplier(s) for particular product(s). As shown, the supplier risk identification system may include a product storage 202 and technical-profile storage 204, a risk-rating applicator 206 coupled to the respective storage, and a risk assessor 208 coupled to the risk-rating applicator.

The product storage 202 may be configured to store characteristic elements applicable to one or more products, and the technical-profile storage 204 may be configured to store technical-profile elements applicable to one or more manufacturing suppliers. In some examples, the characteristic elements and technical-profile elements may include text-based expressions such as statements, questions or the like, which may be applicable to products and manufacturing suppliers. The characteristic elements may relate to characteristics of a particular product and include, for example, questions related to its technological maturity, its complexity, its criticality to the program and/or its on-time delivery, the availability of alternative product(s), and the like. The technical-profile elements may relate to characteristics of a particular manufacturing supplier and/or its past performance. More particularly, for example, the technical-profile elements may include questions related to a supplier's technical performance, infrastructure, organizational structure, sub-tier management, domicile, cooperation, communication, risk management, ability to work with an integrated schedule, whether the supplier controls a key technology, and the like.

The risk-rating applicator 206 may be configured to receive assignment of quantitative risk ratings to respective characteristic elements and respective technical-profile elements based on applicability of the respective characteristic elements to a particular product and a particular manufacturing supplier. The risk-rating applicator may receive these assignments from an input system, such as the input system 102 of FIG. 1, which in some examples, may receive the assignments from a user of the STO risk assessment system 100.

The risk rating for a characteristic element or technical-profile element may indicate a level of applicability of a product or manufacturing supplier to the respective characteristic element or technical-profile element, where in some examples, an increased applicability may correspond to an increased risk (or vice versa). In some examples, the risk rating may be an integer in the range of 0 to 5 in increasing applicability (increasing risk), where a rating of 0 may represent a complete inapplicability (zero risk), a rating of 1 may represent the lowest applicability (lowest positive risk), and a rating of 5 may represent the highest applicability (highest risk). And in some examples, the risk ratings for the characteristic elements may be assigned according to a set of rating guidelines, as may the risk ratings for the technical-profile elements.

The risk assessor 208 may be configured to generate a technical risk assessment of the particular manufacturing supplier for the particular product, with the technical risk assessment including a plurality of risk factors. Similar to the characteristic elements and technical-profile elements, the risk factors may include text-based expressions such as statements, questions or the like. These expressions may relate to current or anticipated future performance of a particular manufacturing supplier. These risk factors may include, for example, questions related to requirements management, requirements verification plan and/or test procedure adequacy, design compliance to requirements sub-tier technical oversight, systems engineering process implementation, meeting scheduling milestones, technical development process management, technical review effectiveness, first-time quality and/or delivery of engineering SDRLs (supplier data requirements lists), and the like. Other examples of suitable risk factors include questions related to technical metrics reporting and management, effective defect containment and disposition, corrective action responsiveness and/or resolution effectiveness, effective change management implementation, requirements quality, production and quality management system, disruptive risks, and the like.

Each of the risk factors of the technical risk assessment may be related to one or more characteristic elements and technical-profile elements. The characteristic element(s) and technical-profile element(s) related to each risk factor may be classified in one or more tiers based on their relevance to the risk factor. For example, more-relevant characteristic element(s) and technical-profile element(s) may be classified as upper-tier, while lesser-relevant characteristic element(s) and technical-profile element(s) may be classified as lower-tier.

Generation of the technical risk assessment may include the risk assessor 208 being configured to receive assignment of quantitative parameters and calculate risk scores for respective risk factors. The risk assessor may receive these assignments from an input system, such as the input system 102 of FIG. 1, which in some examples, may receive the assignments from a user of the STO risk assessment system 100. In some examples, the quantitative parameters may include, for each risk factor, a likelihood and a consequence, and perhaps also a weight of the risk factor relative to others of the risk factors.

The likelihood for a risk factor may indicate the likelihood that a manufacturing supplier satisfies or does not satisfy the respective risk factor, where in some examples, an increased likelihood may correspond to an increased risk (or vice versa). In some examples, the likelihood may be an integer in the range of 1 to 5 in increasing likelihood (increasing risk), where a rating of 1 may represent the lowest likelihood (lowest risk), and a rating of 5 may represent the highest likelihood (highest risk). And in some examples, the likelihood for the risk factors may be assigned according to a set of guidelines.

The consequence for a risk factor may indicate the negative consequence to the project of the manufacturing supplier satisfying or not satisfying the respective risk factor, where in some examples, an increased consequence may correspond to an increased risk (or vice versa). In some examples, the consequence may be an integer in the range of 1 to 5 in increasing negative consequence (increasing risk), where a rating of 1 may represent the lowest negative consequence (lowest risk), and a rating of 5 may represent the highest negative consequence (highest risk). Similar to other examples, in some examples, the consequence for the risk factors may be assigned according to a set of guidelines.

Even further, in some examples, the consequence may be divided into the negative consequence to multiple measures of performance of the project, such as technical, schedule and cost. In these examples, the consequences to the respective measures may be rated, and the consequence for the risk factor selected based on these consequences—such as by taking the highest assigned consequence of one of the measures as that of the risk factor. Also in these examples, similar to before, the consequences to the respective performance measures may be assigned according to respective sets of guidelines.

The weight for a risk factor may indicate its importance to the technical risk assessment relative to others of the risk factors. The weight may be given in a number of different manners such as by a quantitative percentage. In some examples, all of the risk factors of the technical risk assessment may by default have an equal weight, which may total less than or equal to 100 percent. In these examples, the weights may be adjustable (e.g., user adjustable) to emphasize or deemphasize various ones of the risk factors.

The risk assessor 208 may calculate the risk score for a risk factor as a function of the quantitative parameters for the risk factor, and the quantitative risk ratings assigned to the characteristic element(s) and technical-profile element(s) related to the risk factor. In some examples, the risk score may be calculated further as a function of the weight. And even further, in some examples, the risk score may be calculated based on the tier(s) of the characteristic element(s) and technical-profile element(s) related to the risk factor.

In some more particular examples, the risk assessor 208 may calculate the risk score for a risk factor according to the following:

Risk Score=Likelihood×Consequence×Total Weight

In the preceding, Total Weight may represent a total weight of the risk factor. In some examples, the total weight may be a function of the weight of the risk factor, and added weight that may be based on the quantitative risk ratings of characteristic element(s) and technical-profile element(s) related to the risk factor, and perhaps also their tier(s). In examples including upper-tier and lower-tier elements (characteristic and technical-profile), the added weight may include upper-tier weights and lower-tier weights. Similar to the weight of the risk factor, in some examples, the upper-tier weights and lower-tier weights may be given in a number of different manners such as by quantitative percentages.

More particularly, for example, the total weight for a risk factor may be calculated according to the following:

Total Weight=Risk Factor Weight+ΣUpper-Tier Weights+ΣLower-Tier Weights

Here, each related characteristic element and technical-profile element may have a corresponding upper-tier weight or lower-tier weight selected according to its tier and risk rating, such as in accordance with the following table:

| | Upper-Tier Element | | | | | | Lower-Tier Element | | | | | |
|---|---|---|---|---|---|---|---|---|---|---|---|---|
| Risk Rating | 0 | 1 | 2 | 3 | 4 | 5 | 0 | 1 | 2 | 3 | 4 | 5 |
| Upper-Tier | 0 | 0 | 0 | 4 | 6 | 8 | — | — | — | — | — | — |
| Weight | | | | | | | | | | | | |
| Lower-Tier | — | — | — | — | — | — | 0 | 0 | 0 | 1 | 2 | 3 |
| Weight | | | | | | | | | | | | |

As illustrated by the example table, the related elements may add weight to the risk factor (relative to other risk factors), with upper-tier elements adding greater weight than lower-tier elements. And some elements (e.g., those whose risk ratings are 0, 1 or 2) may effectively add no weight (upper-tier/lower-tier weight 0) to the risk factor.

To further illustrate these calculations, consider a risk factor having a likelihood of 4, a consequence of 4, and a weight of 30. Also consider the risk factor as being related to upper-tier elements (characteristic and/or technical-profile) having risk ratings of 4 and 3 and 1, and lower-tier elements (characteristic and/or technical-profile) having risk ratings of 4 and 1 and 1. In this example, the total weight of the risk factor may be calculated as follows:

Total Weight=30+(6+4+0)+(2+0+0)=42

And the risk score for the risk factor may be calculated as follows:

Risk Score=4×4×42=672

The risk assessor 208 may calculate the risk score for each risk factor of the technical risk assessment. In some examples, these risk scores may be considered raw scores, and the risk assessor may be further configured to normalize the scores to thereby calculate a corresponding normalized risk score for each risk factor.

FIG. 3 illustrates various elements of a suitable self-assessment system 300, which in some example implementations of the present disclosure may correspond to the self-assessment system 106 of FIG. 1. As indicated above, the self-assessment system may be generally configured to generate a self-assessment of the customer to which the particular manufacturing supplier(s) may provide the particular product(s). As shown, the self-assessment system may include a product storage 302 and technical-profile storage 304, a risk-rating applicator 306 coupled to the respective storage, and a self-assessor 308 coupled to the risk-rating applicator.

The product storage 302 may be configured to store characteristic elements applicable to one or more products, and the technical-profile storage 304 may be configured to store technical-profile elements applicable to one or more manufacturing suppliers. The risk-rating applicator 306 may be configured to receive assignment of quantitative risk ratings to respective characteristic elements and respective technical-profile elements based on applicability of the respective characteristic elements to a particular product and a particular manufacturing supplier. In some examples, the product storage 302 and technical-profile storage 304 may correspond to the product storage 202 and technical-profile storage 204 of the supplier risk identification system 200 of FIG. 2. And in some examples, the risk-rating applicator 306 may correspond to the risk-rating applicator 206 of the respective supplier risk identification system 200.

The self-assessor 308 may be configured to generate a self-assessment of the customer, with the self-assessment including self-assessment elements for respective risk factors of a technical risk assessment such as that generated by the above-described supplier risk identification system 104, 200. Similar to the risk factors, the self-assessment elements may include text-based expressions such as statements, questions or the like. These expressions may relate to performance of the customer in providing support to a particular manufacturing supplier. These self-assessment elements may include, for example, questions related to requirements quality and/or change flow-down, requirements and statement of work validation, customer/supplier configuration management (CM) plan integration, management of supplier technical risk, effectiveness of supplier technical oversight, technical meeting effectiveness, the customer's relationship with the supplier and/or its capability to assist the supplier, the customer's ability to integrate the supplier's product, customer-furnished tooling and test equipment, and the like.

Each of the self-assessment elements of the self-assessment may be related to one or more characteristic elements and technical-profile elements. This may occur, for example, through the respective risk factors to which the characteristic element(s) and technical-profile element(s) are related. Or in some examples, the relationship may occur more directly between each of the self-assessment elements and characteristic element(s) and technical-profile element(s). In these examples, similar to before, the related characteristic element(s) and technical-profile element(s) may be classified in one or more tiers based on their relevance to the self-assessment element.

The self-assessor 308 may be configured to receive assignment of quantitative parameters and calculate scores for respective self-assessment elements. In some examples, the quantitative parameters may include, for each self-assessment element, a likelihood and a consequence, and perhaps also a weight of the self-assessment element relative to others of the self-assessment elements. These quantitative parameters may be similar to those described above. The self-assessor may calculate the score for a self-assessment element as a function of the quantitative parameters for the self-assessment element, and perhaps also as a function of the weight. And in some examples, the score may be calculated further based on the quantitative risk ratings assigned to characteristic element(s) and technical-profile element(s) related to the self-assessment element, or even further based on their tier(s). These calculations may be performed in a manner similar to that described above.

Briefly returning now to FIG. 1, as explained above, the STO risk assessment system 100 may include an output system 108 generally configured to generate visual artifact(s) of the technical risk assessment(s) and/or self-assessment(s). These visual artifact(s) may be formatted in any of a number of different manners, such as in the form of one or more reports that may be displayed, printed or the like. In some examples, the visual artifact(s) may include a risk matrix on which at least some of the risk factors are identified in an arrangement according to their likelihood and consequence, or a tornado diagram in which at least some of the risk factors are identified based on and in an arrangement according to their risk score. These artifact(s) may be generated for a single manufacturing supplier, or in some examples multiple manufacturing suppliers. In the case of multiple manufacturing suppliers in particular, the output system may generate visual artifact(s) of one or more comparisons of the technical risk assessments of the respective manufacturing suppliers, such as in the form of a risk matrix, tornado diagram or the like.

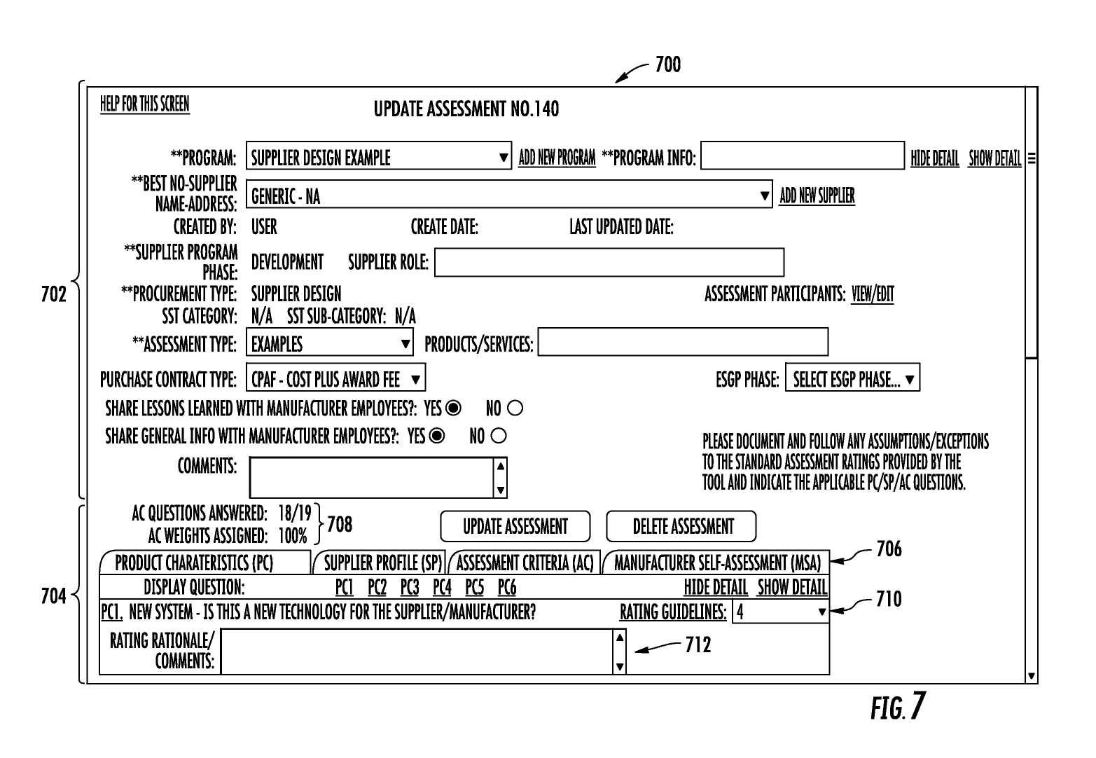

FIGS. 4, 5 and 6 illustrate more particular examples of visual artifact(s) of a suitable single-supplier risk assessment, multiple-supplier risk assessment, and self-assessment, respectively, according to example implementations of the present disclosure in which the artifacts may be presented in the form of reports. As shown in FIG. 4, a single-supplier risk assessment report 400 may identify at least some of the risk factors of an appropriate technical risk assessment. In some examples, the report may include all of the risk factors, or only a subset of the risk factors such as a number (e.g., five) of the highest-scoring risk factors. The report may include the risk scores 402 for the identified risk factors. In some examples, the report may also include related assessment data 404 from the technical risk assessment, such as the quantitative parameters for the identified risk factors including the likelihood, consequence and/or weight (in some examples the total weight). And as indicated above, the report may include a risk matrix 406 and/or tornado diagram 408 for the identified risk factors.

FIG. 5 illustrates a multiple-supplier risk assessment report 500. Similar to the single-supplier risk assessment report 400, the multiple-supplier report may identify at least some of the risk factors of technical risk assessments for multiple manufacturing suppliers. The report may likewise also include the risk scores 502 for the identified risk factors. And the report may include a risk matrix 504 and/or tornado diagram 506 for the identified risk factors.

FIG. 6 illustrates a self-assessment report 600. This report may be similar to the single-supplier risk assessment report 400 but for a self-assessment instead of a technical risk assessment. Thus, this report may identify at least some of the self-assessment elements of an appropriate self-assessment. In some examples, the report may include all of the self-assessment elements, or only a subset of the self-assessment elements such as a number (e.g., five) of the highest-scoring self-assessment elements. The report may include the scores 602 for the identified self-assessment elements. In some examples, the report may also include related assessment data 604 from the self-assessment, such as the quantitative parameters for the identified self-assessment elements including the likelihood, consequence and/or weight (in some examples the total weight). And similar to the other reports, this report may include a risk matrix 606 and/or tornado diagram 608 for the identified self-assessment elements.

Again returning to FIG. 1, the STO risk assessment system 100 may further include a risk mitigation system 110 generally configured to establish risk descriptor(s) for each of one or more of the risk factors, and risk mitigation action(s) for each of one or more of the risk descriptors. In some examples, the risk descriptor for a risk factor may include a text-based expression such as a statement that describes one or more issues to the program that may be caused by the risk factor, and a risk factor may have one or more risk descriptors that may be established. Similarly, in some examples, the risk mitigation action for a risk descriptor may include a text-based expression such as a statement that describes one or more actions that may be taken to address or otherwise mitigate the risk factor that may cause the issue, and that may therefore address or otherwise mitigate the issue. And a risk descriptor may have one or more risk mitigation actions that may be established.

To further illustrate example implementations of the present disclosure, reference is now made to FIGS. 7-16, which illustrate example windows of graphical user interfaces (GUIs) that may be navigated by a user to carry out example implementations of the present disclosure. FIG. 7 illustrates a GUI including one or more windows that may be displayed or otherwise presented in a predetermined viewable area that may be scrollable. The windows may include a main window 700 having a first area 702 in which information identifying a program, manufacturing supplier and product may be received.

The main window 700 may also have a second area 704 in which characteristic elements, technical-profile elements, risk factors and self-assessment elements may be displayed, such as via a group of tabs 706 including a tab for the characteristic elements, a tab for the technical-profile elements, a tab for the risk factors and a tab for the self-assessment elements. This second area may also include a portion 708 in which the number of risk factors for which quantitative parameters have been assigned, and the weight assigned to those risk factors. In these examples, characteristic elements, technical-profile elements, risk factors and self-assessment elements may be referred to as product characteristics (PC), supplier profile (SP), assessment criteria (AC) and manufacturer (customer) self-assessment (MSA), respectively.

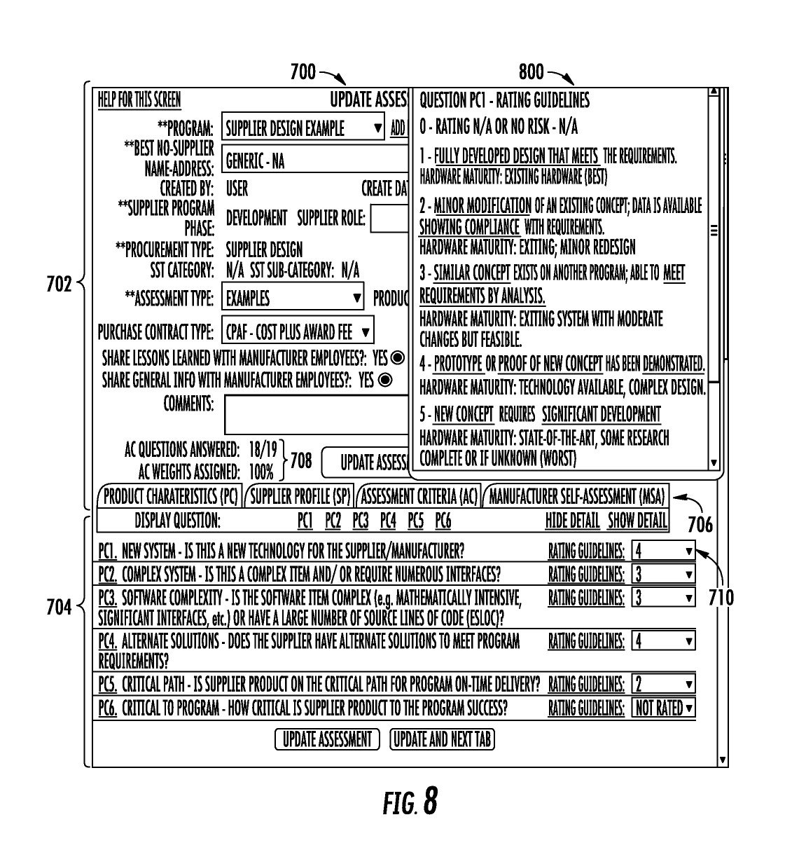

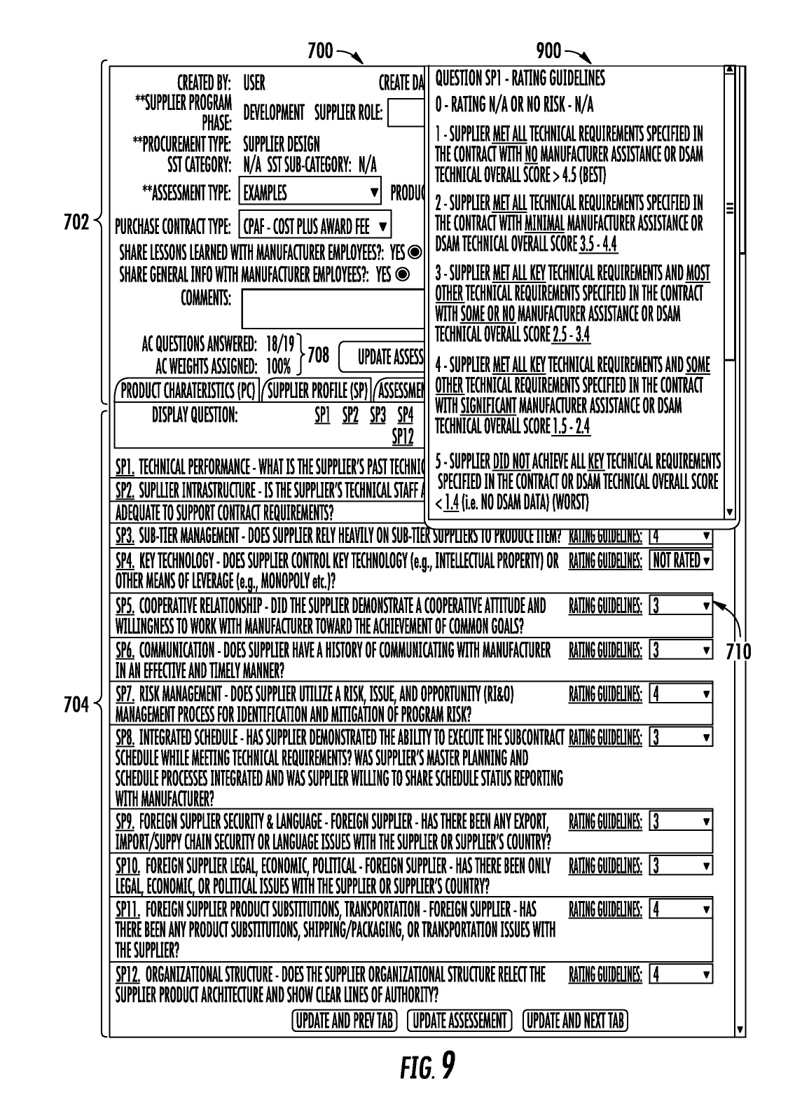

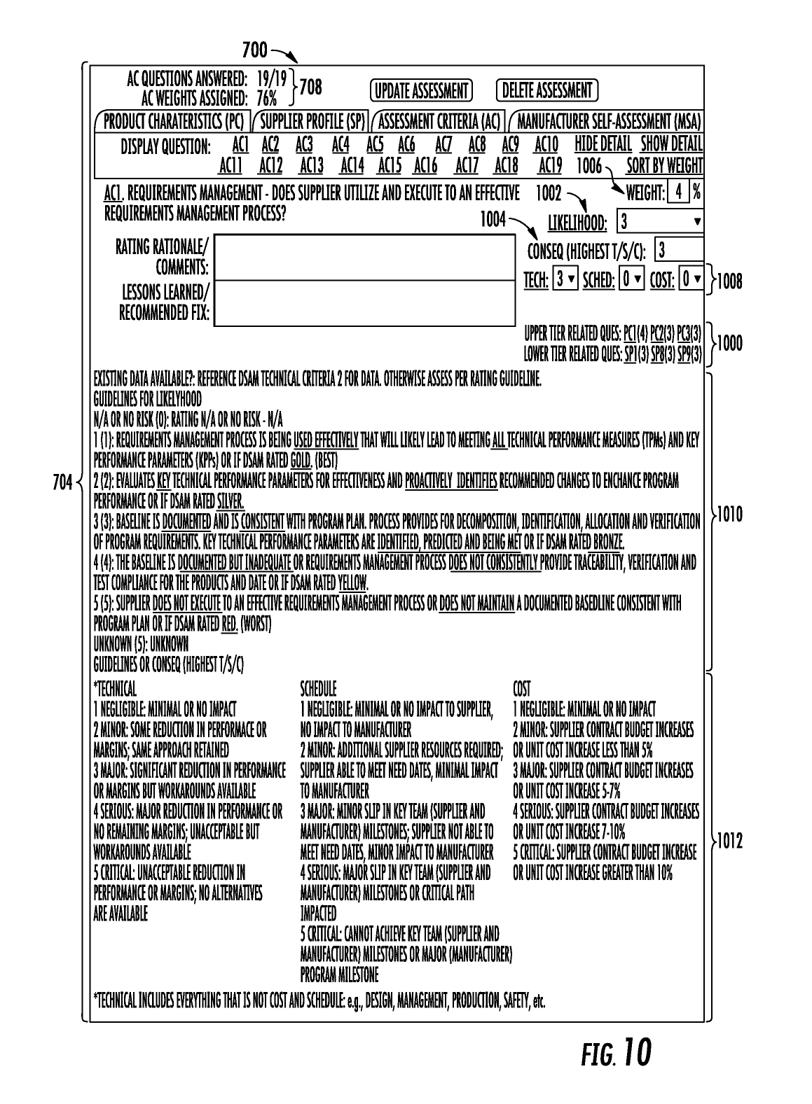

In FIG. 7 and even further in FIG. 8, the second area 704 is shown displaying characteristic elements (product characteristics) applicable to one or more products, and where assignment of risk ratings 710 may be received via an appropriate control such as a drop-down list for each characteristic element. FIG. 7 further illustrates a control 712 such as a text box in which a rationale and/or comments related to the assigned risk rating may be received, a detail which may be selectively hidden from view such as in FIG. 8. And as further shown in FIG. 8, the windows of the GUI may include an area or window 800 such as a popup window in which guidelines for assignment of the risk rating for one or more of the characteristic elements may be displayed, and which in some examples may be accessed in response to selection of an appropriate control.

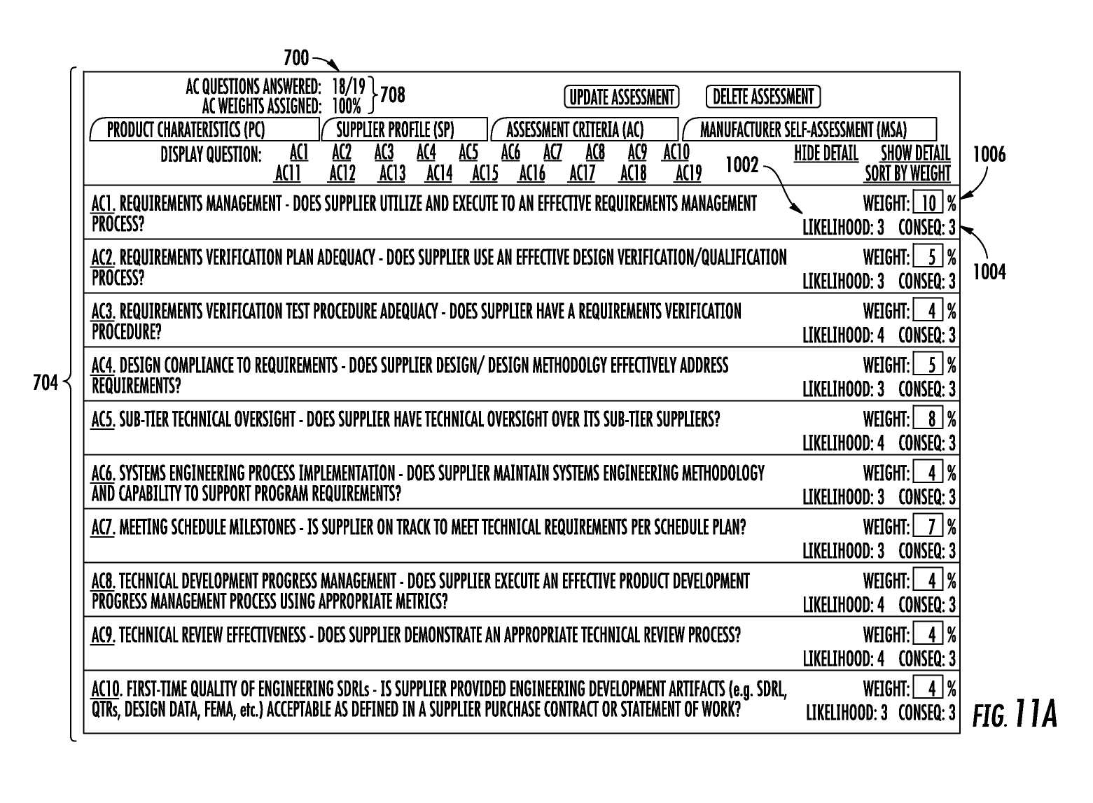

In FIG. 9, the second area 704 is shown displaying technical-profile elements (supplier profile) applicable to one or more manufacturing suppliers, and where assignment of risk ratings 710 may be received via an appropriate control such as a drop-down list for each technical-profile element. FIG. 9 further illustrates an area or window 900 such as a popup window in which guidelines for assignment of the risk rating for one or more of the technical-profile elements may be displayed, such as in response to selection of an appropriate control.

In FIG. 10, the second area 704 is shown displaying a risk factor (assessment criteria) for a technical assessment, and displaying the characteristic element(s) and technical-profile element(s) 1000 related to the risk factor, which may be classified into upper and lower tiers. Here, the risk factor may be related to three characteristic elements (product characteristics) classified as upper tier, and three technical-profile elements (supplier profile) classified as lower tier. These elements may have assigned risk ratings, which are shown parenthetically—although in some examples, only those risk ratings that affect the total weight may be shown (the others adding 0 to the total weight).

Also in FIG. 10, the second area 704 may be where assignment of quantitative parameters such as a likelihood 1002, consequence 1004 and weight 1006 may be received via appropriate controls such as drop-down lists for each quantitative parameter for each risk factor. In the illustrated example, the consequence may be divided into multiple measures of performance 1008, such as technical, schedule and cost. In these examples, the consequences to the respective measures may be rated, and the consequence for the risk factor selected based on these consequences—such as by taking the highest assigned consequence of one of the measures as that of the risk factor. As before, guidelines for assignment of the quantitative parameters may be displayed, including guidelines for assignment of the likelihood 1010 and those for assignment of the consequences to the measures of performance 1012. But in the example of FIG. 10, these guidelines are shown in the second area of the main window 700, instead of in another window (although they may instead be shown in another window—as may those shown in another window be instead shown in the main window).

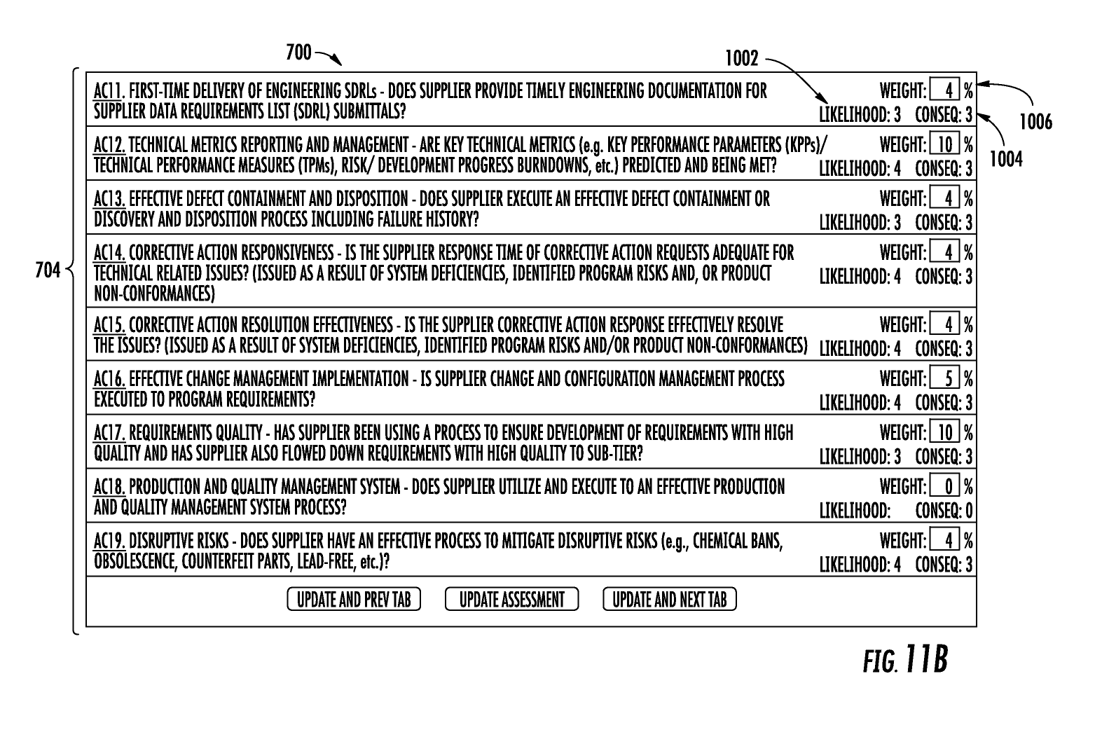

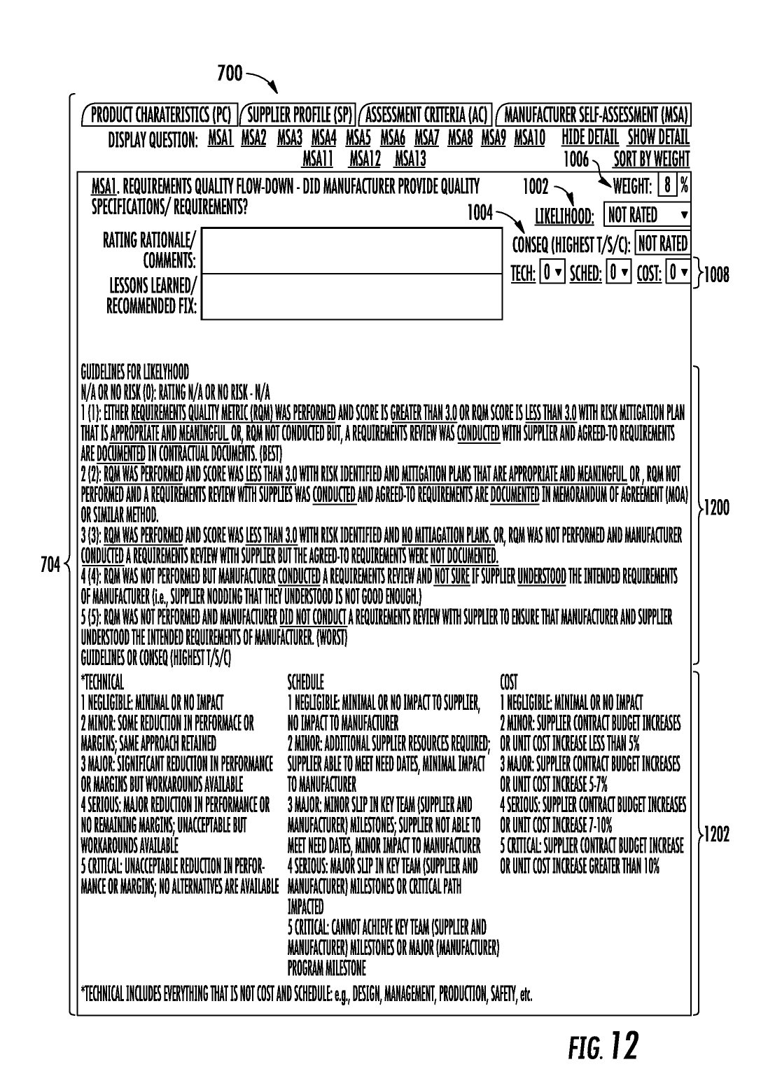

FIGS. 11A and 11B (collectively FIG. 11) illustrate a view of the second area 704 similar to that shown in FIG. 10 in that it displays risk factors. In FIG. 11, though, the second area displays a plurality of risk factors in more of a summary view. The risk factors and assigned quantitative parameters may be displayed. This view may better facilitate assignment of the weight to one or more risk factors, which may be relative to others of the risk factors. And thus, in this view, the assigned weight may be received, while the other quantitative parameters may be merely shown.

FIG. 12 is similar to FIG. 10 but for a self-assessment instead of a technical assessment. In FIG. 12, the second area 704 is shown displaying a self-assessment element (manufacturer self-assessment) for a self-assessment, and where assignment of quantitative parameters such as a likelihood 1002, consequence 1004 and weight 1006 may be received via appropriate controls such as drop-down lists for each quantitative parameter for each self-assessment element. Again, the consequence may be divided into multiple measures of performance 1008, such as technical, schedule and cost. Also similar to before, guidelines for assignment of the likelihood 1200 and those for assignment of the consequences to the measures of performance 1202 may also be displayed in the second area of the main window 700.

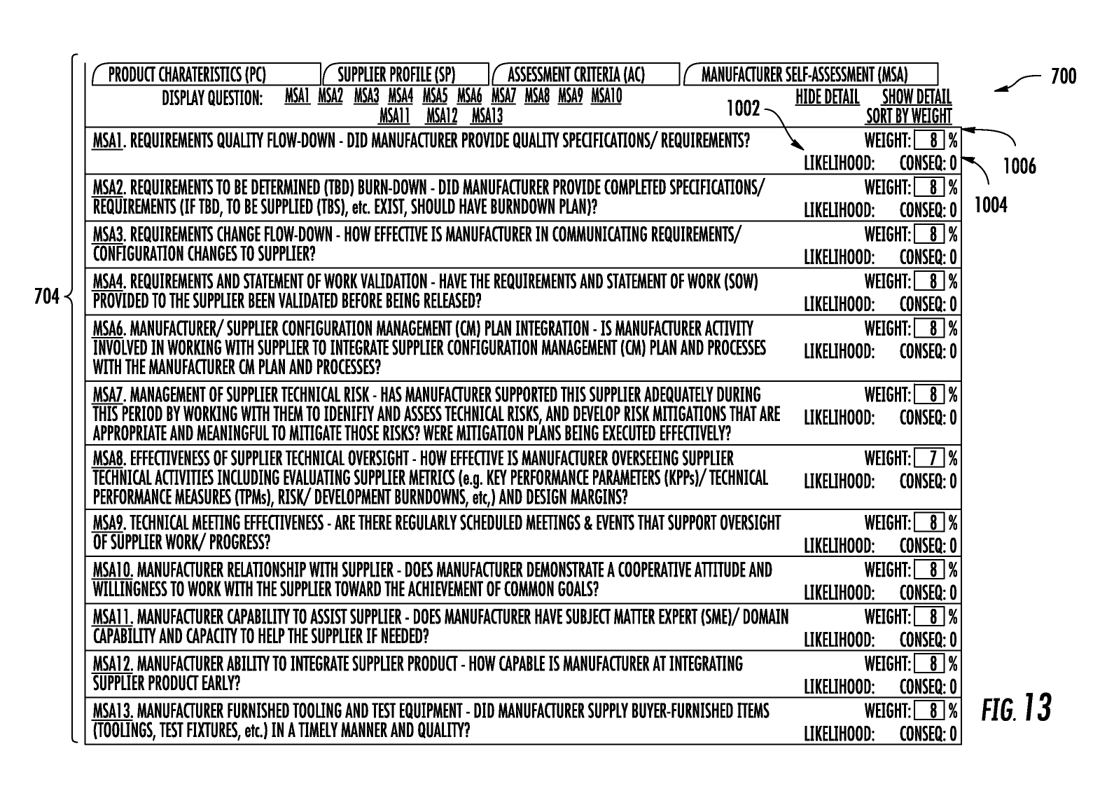

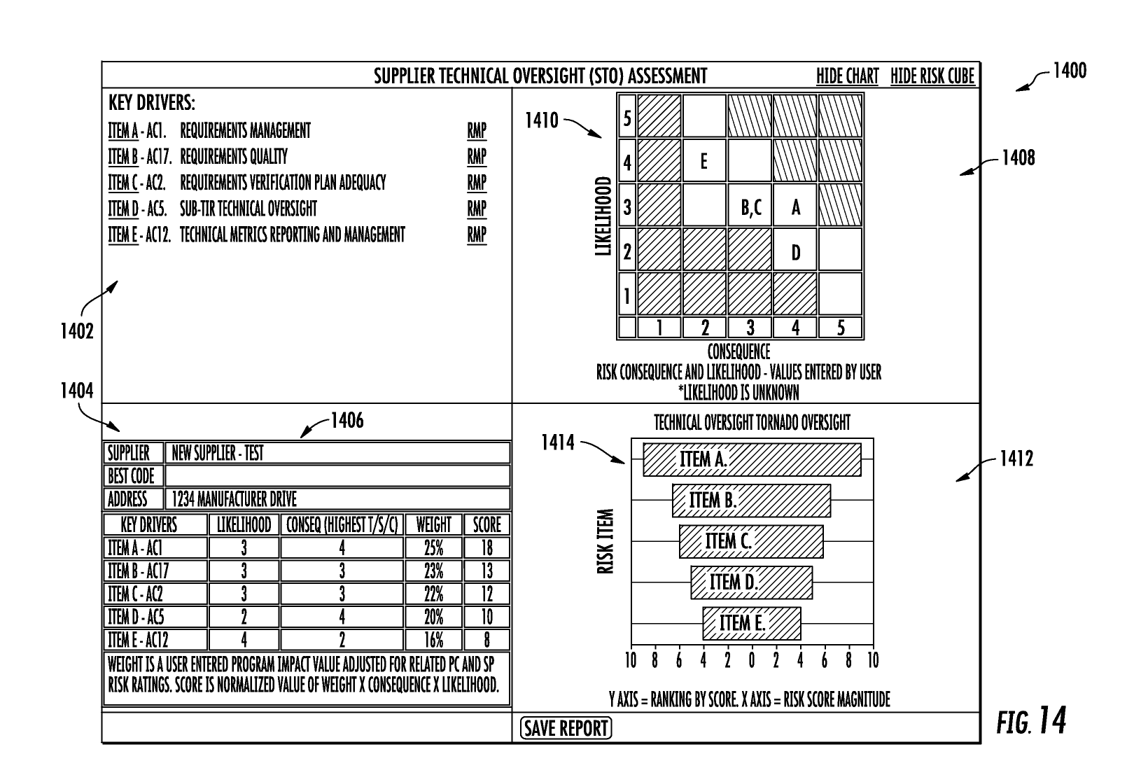

FIG. 13 is similar to FIG. 11 but for a self-assessment instead of a technical assessment. In FIG. 13, the second area 704 displays a plurality of self-assessment elements in more of a summary view. The self-assessment elements and assigned quantitative parameters may be displayed. And similar to before, this view may better facilitate assignment of the weight to one or more risk factors, which may be relative to others of the risk factors. The assigned weight may therefore be received in this view, while the other quantitative parameters may be merely shown.

FIG. 14 illustrates a GUI for displaying visual artifact(s) of a suitable single-supplier risk assessment. As shown, the GUI includes a main window 1400 that may be divided into a plurality of area in which respective visual artifacts may be displayed. The areas of the main window may include a first area 1402 in which at least some of the risk factors of an appropriate technical risk assessment may be identified. In the illustrated examples, the first area may identify the five highest-scoring risk factors. A second area 1404 of the main window may include the risk scores for the identified risk factors, and their quantitative parameters including the likelihood, consequence, weight (in some examples the total weight), such as in a table 1406. A third area 1408 of the main window may include a risk matrix 1410 for the identified risk factors, and a fourth area 1412 of the main window may include a tornado diagram 1414 for the identified risk factors.

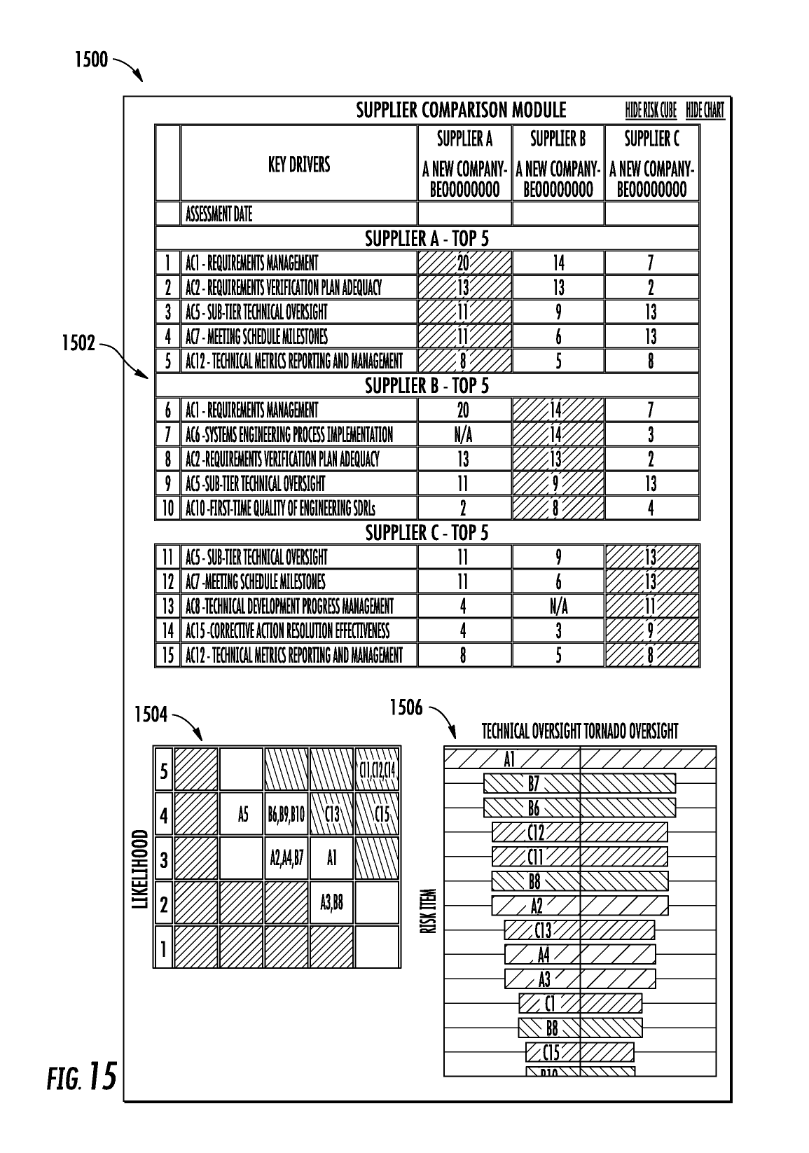

FIG. 15 illustrates a GUI for displaying visual artifact(s) of a suitable multiple-supplier risk assessment. As shown, the GUI includes a main window 1500 in which at least some of the risk factors of appropriate technical risk assessments for multiple manufacturing suppliers may be identified, and include the risk scores for those risk factors, such as in a table 1502. In the illustrated examples, the first area may identify the five highest-scoring risk factors for each manufacturing supplier, and include the risk scores for their five highest-scoring risk factors as well as the five highest-scoring risk factors for the other manufacturing suppliers (some of which may be the same risk factors). The main window may also include a risk matrix 1504 and a tornado diagram 1506 for the identified risk factors for the multiple manufacturing suppliers.

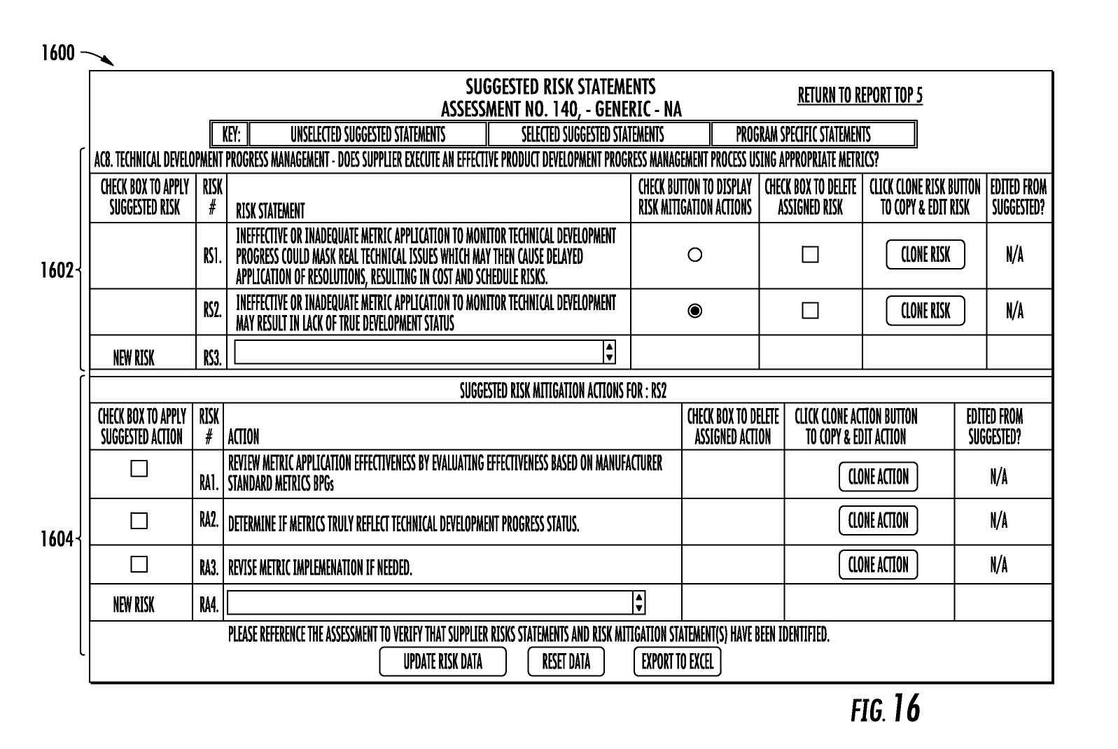

FIG. 16 illustrates a GUI for displaying risk descriptor(s) and risk mitigation action(s), and which in some examples may be accessed in response to selection of an appropriate control in the visual artifact(s)—e.g., “RMP” link in area 1402 of window 1400. As shown, the GUI may include a window 1600 with a first area 1602 in which risk descriptor(s) for a risk factor may be displayed, and a second area 1604 in which risk mitigation action(s) for each of one or more of the risk descriptors may be displayed. In this example, risk descriptors may be referred to as risk statements. As shown, the risk descriptor(s) may be selectable via an appropriate control such as a radio button, and selection of the radio button for a risk descriptor may cause the GUI to display risk mitigation action(s) for the selected risk descriptor(s) in the second area. In some examples, this may thereby establish the respective risk descriptor(s) and risk mitigation action(s).

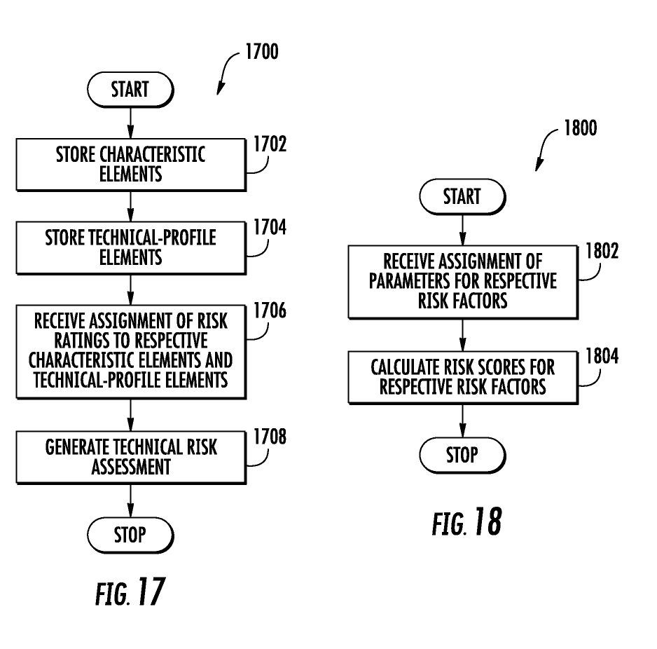

FIGS. 17 and 18 illustrate various operations in methods 1700, 1800 according to example implementations of the present disclosure. As shown at blocks 1702 and 1704 of FIG. 17, the method 1700 may include storing characteristic elements applicable to one or more products, and storing technical-profile elements applicable to one or more manufacturing suppliers. The method may include receiving assignment of quantitative risk ratings to respective characteristic elements and respective technical-profile elements based on applicability of the respective characteristic elements to a particular product and a particular manufacturing supplier, as shown at block 1706. And the method may include generating a technical risk assessment of the particular manufacturing supplier for the particular product, with the technical risk assessment including a plurality of risk factors each of which is related to one or more characteristic elements and technical-profile elements, as shown at block 1708.

FIG. 1800 illustrates various operations in a method 1800 according to which the technical risk assessment may be generated. As shown at blocks 1802 and 1804, this method may include receiving assignment of quantitative parameters and calculating risk scores for respective risk factors, and wherein for each risk factor, the quantitative parameters include a likelihood and a consequence, and the risk score is calculated as a function of the quantitative parameters for the risk factor, and the quantitative risk ratings assigned to the characteristic element(s) and technical-profile element(s) related to the risk factor.

According to example implementations of the present disclosure, the STO risk assessment system 100 and it subsystems including the input system 102, supplier risk identification system 104, self-assessment system 106, output system 108 and risk mitigation system 110 may be implemented by various means. Similarly, the examples of an input system 200, supplier risk identification system 300, self-assessment system 400, output system 500 and risk mitigation system 600, including each of their respective elements, may be implemented by various means according to example implementations. And the methods 1700, 1800 of example implementations may be implemented by various means. Means for implementing the systems, subsystems and their respective elements, and the methods described herein, may include hardware, alone or under direction of one or more computer program code instructions, program instructions or executable computer-readable program code instructions (at times generally referred to as “computer programs,” e.g., software, firmware, etc.) from a computer-readable storage medium.

In some examples, one or more apparatuses may be provided that are configured to function as or otherwise implement the systems, subsystems and respective elements shown and described herein, such as to carry out operations of methods shown and described herein. In examples involving more than one apparatus, the respective apparatuses may be connected to or otherwise in communication with one another in a number of different manners, such as directly or indirectly via a wired or wireless network or the like.

Generally, an apparatus of exemplary implementations of the present disclosure may comprise, include or be embodied in one or more fixed or portable electronic devices. Examples of suitable electronic devices include a smartphone, tablet computer, laptop computer, desktop computer, workstation computer, server computer or the like. The apparatus may include one or more of each of a number of components such as, for example, a processor (e.g., processor unit) connected to a memory (e.g., storage device).

The processor is generally any piece of computer hardware that is capable of processing information such as, for example, data, computer programs and/or other suitable electronic information. The processor is composed of a collection of electronic circuits some of which may be packaged as an integrated circuit or multiple interconnected integrated circuits (an integrated circuit at times more commonly referred to as a “chip”). The processor may be configured to execute computer programs, which may be stored onboard the processor or otherwise stored in the memory (of the same or another apparatus).

The processor may be a number of processors, a multi-processor core or some other type of processor, depending on the particular implementation. Further, the processor may be implemented using a number of heterogeneous processor systems in which a main processor is present with one or more secondary processors on a single chip. As another illustrative example, the processor may be a symmetric multi-processor system containing multiple processors of the same type. In yet another example, the processor may be embodied as or otherwise include one or more application-specific integrated circuits (ASICs), field-programmable gate arrays (FPGAs) or the like. Thus, although the processor may be capable of executing a computer program to perform one or more functions, the processor of various examples may be capable of performing one or more functions without the aid of a computer program.

The memory is generally any piece of computer hardware that is capable of storing information such as, for example, data, computer programs and/or other suitable information either on a temporary basis and/or a permanent basis. The memory may include volatile and/or non-volatile memory, and may be fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks may include compact disk-read only memory (CD-ROM), compact disk-read/write (CD-R/W), DVD or the like. In various instances, the memory may be referred to as a computer-readable storage medium which, as a non-transitory device capable of storing information, may be distinguishable from computer-readable transmission media such as electronic transitory signals capable of carrying information from one location to another. Computer-readable medium as described herein may generally refer to a computer-readable storage medium or computer-readable transmission medium.

In addition to the memory, the processor may also be connected to one or more interfaces for displaying, transmitting and/or receiving information. The interfaces may include a communications interface (e.g., communications unit) and/or one or more user interfaces. The communications interface may be configured to transmit and/or receive information, such as to and/or from other apparatus(es), network(s) or the like. The communications interface may be configured to transmit and/or receive information by physical (wired) and/or wireless communications links. Examples of suitable communication interfaces include a network interface controller (NIC), wireless NIC (WNIC) or the like.

The user interfaces may include a display and/or one or more user input interfaces (e.g., input/output unit). The display may be configured to present or otherwise display information to a user, suitable examples of which include a liquid crystal display (LCD), light-emitting diode display (LED), plasma display panel (PDP) or the like. The user input interfaces may be wired or wireless, and may be configured to receive information from a user into the apparatus, such as for processing, storage and/or display. Suitable examples of user input interfaces include a microphone, image or video capture device, keyboard or keypad, joystick, touch-sensitive surface (separate from or integrated into a touchscreen), biometric sensor or the like. The user interfaces may further include one or more interfaces for communicating with peripherals such as printers, scanners or the like.

As indicated above, program code instructions may be stored in memory, and executed by a processor, to implement functions of the systems, subsystems and their respective elements described herein, such as to carry out operations of methods shown and described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, a processor or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processor or other programmable apparatus to configure the computer, processor or other programmable apparatus to execute operations to be performed on or by the computer, processor or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processor or other programmable apparatus provide operations for implementing functions described herein.

Execution of instructions by a processor, or storage of instructions in a computer-readable storage medium, supports combinations of operations for performing the specified functions. It will also be understood that one or more functions, and combinations of functions, may be implemented by special purpose hardware-based computer systems and/or processors which perform the specified functions, or combinations of special purpose hardware and program code instructions.

Many modifications and other implementations of the disclosure set forth herein will come to mind to one skilled in the art to which the disclosure pertains having the benefit of the teachings presented in the foregoing description and the associated drawings. Therefore, it is to be understood that the disclosure is not to be limited to the specific implementations disclosed and that modifications and other implementations are intended to be included within the scope of the appended claims. Moreover, although the foregoing description and the associated drawings describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system comprising:
a product storage configured to store characteristic elements applicable to one or more products;
a technical-profile storage configured to store technical-profile elements applicable to one or more manufacturing suppliers;
a risk-rating applicator coupled to the product storage and technical-profile storage, the risk-rating applicator being configured to receive assignment of quantitative risk ratings to respective characteristic elements and respective technical-profile elements based on applicability of the respective characteristic elements to a particular product and a particular manufacturing supplier; and
a risk assessor coupled to the risk-rating applicator and configured to generate a technical risk assessment of the particular manufacturing supplier for the particular product, the technical risk assessment including a plurality of risk factors each of which is related to one or more characteristic elements and technical-profile elements,
wherein the risk assessor being configured to generate the technical risk assessment includes being configured to receive assignment of quantitative parameters and calculate risk scores for respective risk factors, and wherein for each risk factor, the quantitative parameters include a likelihood and a consequence, and the risk score is calculated as a function of the quantitative parameters for the risk factor, and the quantitative risk ratings assigned to the one or more characteristic elements and technical-profile elements related to the risk factor.

2. The system of claim 1, wherein for each risk factor, the quantitative parameters further include a weight of the risk factor relative to others of the risk factors, the risk score being calculated further as a function of the weight.

3. The system of claim 1, wherein for each risk factor, the one or more characteristic elements and technical-profile elements related to the risk factor are classified in one or more tiers based on their relevance to the risk factor, and wherein for each risk factor, the risk score is calculated further based on the one or more tiers of the one or more characteristic elements and technical-profile elements related to the risk factor.

4. The system of claim 1, wherein the product storage, technical-profile storage, risk-rating applicator and risk assessor are elements of a supplier risk identification system, and wherein the system further comprises:
an output system coupled to the supplier risk identification system, and configured to generate one or more visual artifacts of the technical risk assessment, the one or more visual artifacts including a risk matrix on which at least some of the risk factors are identified in an arrangement according to their likelihood and consequence, or a tornado diagram in which at least some of the risk factors are identified based on and in an arrangement according to their risk score.

5. The system of claim 4, wherein the risk-rating applicator being configured to receive assignment of quantitative risk ratings includes being configured to receive assignment of quantitative risk ratings to respective technical-profile elements for each of a plurality of particular manufacturing suppliers,
wherein the risk assessor being configured to generate the technical risk assessment includes being configured to generate technical risk assessments for respective particular manufacturing suppliers for the particular product, and
wherein the output system being configured to generate one or more visual artifacts includes being configured to generate one or more visual artifacts of one or more comparisons of the technical risk assessments.

6. The system of claim 1, wherein the product storage, technical-profile storage, risk-rating applicator and risk assessor are elements of a supplier risk identification system, and wherein the system further comprises:
a risk mitigation system coupled to the supplier risk identification system, and configured to establish one or more risk descriptors for each of one or more of the risk factors, and one or more risk mitigation actions for each of one or more of the risk descriptors.

7. The system of claim 1, wherein the technical risk assessment is generated for a customer of the particular manufacturing supplier for the particular product, wherein the product storage, technical-profile storage, risk-rating applicator and risk assessor are elements of a supplier risk identification system, wherein the system further comprises:
a self-assessment system configured to generate a self-assessment of the customer, the self-assessment including self-assessment elements for respective risk factors of the technical risk assessment, and
wherein the self-assessment system being configured to generate the self-assessment includes being configured to receive assignment of quantitative parameters and calculate scores for respective self-assessment elements, and wherein for each self-assessment element, the quantitative parameters include a likelihood and a consequence, and the score is calculated as a function of the quantitative parameters for the self-assessment elements.

8. A method comprising:
storing characteristic elements applicable to one or more products;
storing technical-profile elements applicable to one or more manufacturing suppliers;
receiving assignment of quantitative risk ratings to respective characteristic elements and respective technical-profile elements based on applicability of the respective characteristic elements to a particular product and a particular manufacturing supplier; and
generating a technical risk assessment of the particular manufacturing supplier for the particular product, the technical risk assessment including a plurality of risk factors each of which is related to one or more characteristic elements and technical-profile elements,
wherein generating the technical risk assessment includes receiving assignment of quantitative parameters and calculating risk scores for respective risk factors, and wherein for each risk factor, the quantitative parameters include a likelihood and a consequence, and the risk score is calculated as a function of the quantitative parameters for the risk factor, and the quantitative risk ratings assigned to the one or more characteristic elements and technical-profile elements related to the risk factor.

9. The method of claim 8, wherein for each risk factor, the quantitative parameters further include a weight of the risk factor relative to others of the risk factors, the risk score being calculated further as a function of the weight.

10. The method of claim 8, wherein for each risk factor, the one or more characteristic elements and technical-profile elements related to the risk factor are classified in one or more tiers based on their relevance to the risk factor, and
wherein for each risk factor, the risk score is calculated further based on the one or more tiers of the one or more characteristic elements and technical-profile elements related to the risk factor.

11. The method of claim 8 further comprising:
generating one or more visual artifacts of the technical risk assessment, the one or more visual artifacts including a risk matrix on which at least some of the risk factors are identified in an arrangement according to their likelihood and consequence, or a tornado diagram in which at least some of the risk factors are identified based on and in an arrangement according to their risk score.

12. The method of claim 11, wherein receiving assignment of quantitative risk ratings includes receiving assignment of quantitative risk ratings to respective technical-profile elements for each of a plurality of particular manufacturing suppliers,
wherein generating the technical risk assessment includes generating technical risk assessments for respective particular manufacturing suppliers for the particular product, and
wherein generating one or more visual artifacts includes generating one or more visual artifacts of one or more comparisons of the technical risk assessments.

13. The method of claim 8 further comprising:
establishing one or more risk descriptors for each of one or more of the risk factors, and one or more risk mitigation actions for each of one or more of the risk descriptors.

14. The method of claim 8, wherein the technical risk assessment is generated for a customer of the particular manufacturing supplier for the particular product, wherein the method further comprises:
generating a self-assessment of the customer, the self-assessment including self-assessment elements for respective risk factors of the technical risk assessment, and
wherein generating the self-assessment includes receiving assignment of quantitative parameters and calculating scores for respective self-assessment elements, and wherein for each self-assessment element, the quantitative parameters include a likelihood and a consequence, and the score is calculated as a function of the quantitative parameters for the self-assessment elements.

15. A computer-readable storage medium having computer-readable program code stored therein that, in response to execution by a processor, causes an apparatus to at least:
store characteristic elements applicable to one or more products;
store technical-profile elements applicable to one or more manufacturing suppliers;
receive assignment of quantitative risk ratings to respective characteristic elements and respective technical-profile elements based on applicability of the respective characteristic elements to a particular product and a particular manufacturing supplier; and
generate a technical risk assessment of the particular manufacturing supplier for the particular product, the technical risk assessment including a plurality of risk factors each of which is related to one or more characteristic elements and technical-profile elements,
wherein the apparatus being caused to generate the technical risk assessment includes being caused to receive assignment of quantitative parameters and calculate risk scores for respective risk factors, and wherein for each risk factor, the quantitative parameters include a likelihood and a consequence, and the risk score is calculated as a function of the quantitative parameters for the risk factor, and the quantitative risk ratings assigned to the one or more characteristic elements and technical-profile elements related to the risk factor.

16. The computer-readable storage medium of claim 15, wherein for each risk factor, the quantitative parameters further include a weight of the risk factor relative to others of the risk factors, the risk score being calculated further as a function of the weight.

17. The computer-readable storage medium of claim 15, wherein for each risk factor, the one or more characteristic elements and technical-profile elements related to the risk factor are classified in one or more tiers based on their relevance to the risk factor, and
wherein for each risk factor, the risk score is calculated further based on the one or more tiers of the one or more characteristic elements and technical-profile elements related to the risk factor.

18. The computer-readable storage medium of claim 15 having further computer-readable program code stored therein that, in response to execution by the processor, causes the apparatus to further:
generate one or more visual artifacts of the technical risk assessment, the one or more visual artifacts including a risk matrix on which at least some of the risk factors are identified in an arrangement according to their likelihood and consequence, or a tornado diagram in which at least some of the risk factors are identified based on and in an arrangement according to their risk score.

19. The computer-readable storage medium of claim 18, wherein the apparatus being caused to receive assignment of quantitative risk ratings includes being caused to receive assignment of quantitative risk ratings to respective technical-profile elements for each of a plurality of particular manufacturing suppliers,
wherein the apparatus being caused to generate the technical risk assessment includes being caused to generate technical risk assessments for respective particular manufacturing suppliers for the particular product, and
wherein the apparatus being caused to generate one or more visual artifacts includes being caused to generate one or more visual artifacts of one or more comparisons of the technical risk assessments.

20. The computer-readable storage medium of claim 15 having further computer-readable program code stored therein that, in response to execution by the processor, causes the apparatus to further:
establish one or more risk descriptors for each of one or more of the risk factors, and one or more risk mitigation actions for each of one or more of the risk descriptors.

21. The computer-readable storage medium of claim 15, wherein the technical risk assessment is generated for a customer of the particular manufacturing supplier for the particular product, wherein the computer-readable storage medium has further computer-readable program code stored therein that, in response to execution by the processor, causes the apparatus to further:
generate a self-assessment of the customer, the self-assessment including self-assessment elements for respective risk factors of the technical risk assessment, and
wherein the apparatus being caused to generate the self-assessment includes being caused to receive assignment of quantitative parameters and calculate scores for respective self-assessment elements, and wherein for each self-assessment element, the quantitative parameters include a likelihood and a consequence, and the score is calculated as a function of the quantitative parameters for the self-assessment elements.
